(19) United States
(12) Patent Application Publication
(10) Pub. No.: US 2008/0216369 A1
(43) Pub. Date: Sep. 11, 2008

(54) Auxiliary shelf and display

(76) Inventors: Jack T. Bolls, Texarkana, AR (US); Stephen T. Bolls, Texarkana, AR (US)

Correspondence Address: LITMAN LAW OFFICES, LTD., P.O. BOX 15035, CRYSTAL CITY STATION, ARLINGTON, VA, 22215, US

(21) Appl. No.: 11/714,859

(22) Filed: Mar. 7, 2007

(51) Int. Cl. G09F 7/04; G09F 7/18

(52) U.S. Cl. 40/600; 40/584; 40/594

(57) ABSTRACT

The auxiliary shelf and display is a combined display board and collapsible shelf for attachment to an appliance or article of furniture, such as a refrigerator or filing cabinet. The auxiliary shelf and display includes a vertical display portion, which is divided into an upper portion and a lower portion. The upper portion may have user-selectable indicia formed thereon, and the lower portion may have a mirror or an imprinted surface mounted thereto. A shelf portion is pivotally mounted to a lower edge of the vertical display portion so that the lower portion of the vertical display portion is covered by the shelf portion when the shelf portion is in a collapsed configuration. A lower surface of the shelf portion has a display board, such as a corkboard, mounted thereto, which is visible to the user when the shelf is in the collapsed configuration.

### BACKGROUND OF THE INVENTION

1. Field of the Invention

The present invention relates to shelving, and particularly to an auxiliary shelf and display.

2. Description of the Related Art

In households, residents often post notes on the refrigerator, as a home's kitchen typically serves as a well-traveled common area for the residents. Such notes are often posted using small, decorative magnets or with tape. The small magnets typically produce a very weak magnetic field and may be easily knocked from the refrigerator, thus allowing the notes to become easily lost. The use of tape on the refrigerator surface may damage the painted or polished surface. Similarly, office workers often post notes on the sides of filing cabinets using similar means, and the posting of the notes on the filing cabinets suffers from the same problems as those described above.

Further, available shelf space in both kitchens and offices is often limited. Although permanent shelving can be built in either environment, there often is not enough available space for such construction. Although temporary or portable shelving is available, such structures still remain typically bulky, are often utilitarian, and are not designed to coordinate with a home or office environment. It would be desirable to provide a collapsible shelf that further provides the convenience of a display or message center.

Thus, an auxiliary shelf and display solving the aforementioned problems is desired.

### SUMMARY OF THE INVENTION

The auxiliary shelf and display is a combined display board and collapsible shelf for attachment to an appliance or article of furniture, for example, a refrigerator or filing cabinet. The auxiliary shelf and display includes a vertical display portion, which is divided into an upper portion and a lower portion. The vertical display portion preferably has a substantially planar and rectangular configuration having a front surface and a rear surface. The rear surface is adapted for releasable attachment to a support surface of the appliance or article of furniture.

A fastener for releasably securing the rear surface to the appliance or article of furniture is provided. For example, at least one magnetic member, such as a piece of magnetic tape, may be secured to the rear surface of the display portion if the appliance or article of furniture is formed from metal. Alternatively, an adhesive strip may be used for releasably securing the rear surface to a nonmagnetic surface, such as wood paneling.

The upper portion of the vertical display portion may have user-selectable indicia formed thereon, such as advertising-related wording or images, or may have user-selectable and replaceable photographs affixed thereto. The lower portion may have a mirror mounted thereto, or, alternatively, may have an imprinted surface, such as a calendar, formed thereon.

A shelf portion is pivotally mounted to a lower edge of the vertical display portion so that the lower portion of the vertical display portion is covered by the shelf portion when the shelf portion is in a collapsed configuration. The shelf portion includes opposed first and second surfaces, with the first surface being adapted for supporting user-selectable articles when the shelf is in a deployed configuration. The second surface of the shelf portion has a corkboard display disposed thereon, which is visible to the user when the shelf is in the collapsed configuration. The shelf portion is pivotally attached to the vertical display portion through use of a hinge or the like.

An engagement member, such as a peg, may be mounted to a forward edge of the shelf portion, with the engagement member being received within a corresponding recess formed in the periphery of the vertical display portion. The engagement member is releasably held within the recess for frictionally holding the shelf portion to the vertical display portion when the auxiliary shelf and display is in the collapsed configuration.

These and other features of the present invention will become readily apparent upon further review of the following specification and drawings.

### BRIEF DESCRIPTION OF THE DRAWINGS

FIG. 1 is an environmental, perspective view of an auxiliary shelf and display according to the present invention.

FIG. 2 is a side view of the auxiliary shelf and display according to the present invention in a deployed configuration.

FIG. 3 is a side view of the auxiliary shelf and display according to the present invention in a collapsed configuration.

FIG. 4 is a front view of the auxiliary shelf and display according to the present invention in the collapsed configuration of FIG. 3.

FIG. 5 is a front view of the auxiliary shelf and display according to the present invention in the deployed configuration of FIG. 2.

FIG. 6 is a rear view of the auxiliary shelf and display according to the present invention.

Similar reference characters denote corresponding features consistently throughout the attached drawings.

### DETAILED DESCRIPTION OF THE PREFERRED EMBODIMENTS

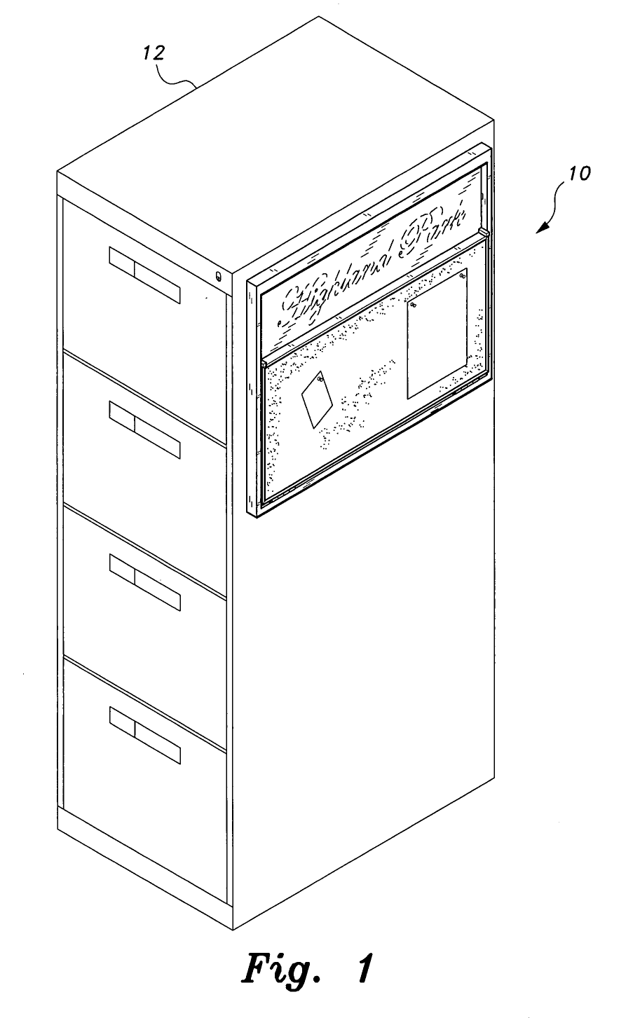

The present invention is directed towards an auxiliary shelf and display 10. As shown in FIG. 1, the auxiliary shelf and display 10 is a combined display board and collapsible shelf for attachment to an appliance or article of furniture, such as a refrigerator or the exemplary filing cabinet 12. It should be understood that filing cabinet 12 is shown for exemplary purposes only, and that the auxiliary shelf and display 1 0 may be attached to any suitable support surface.

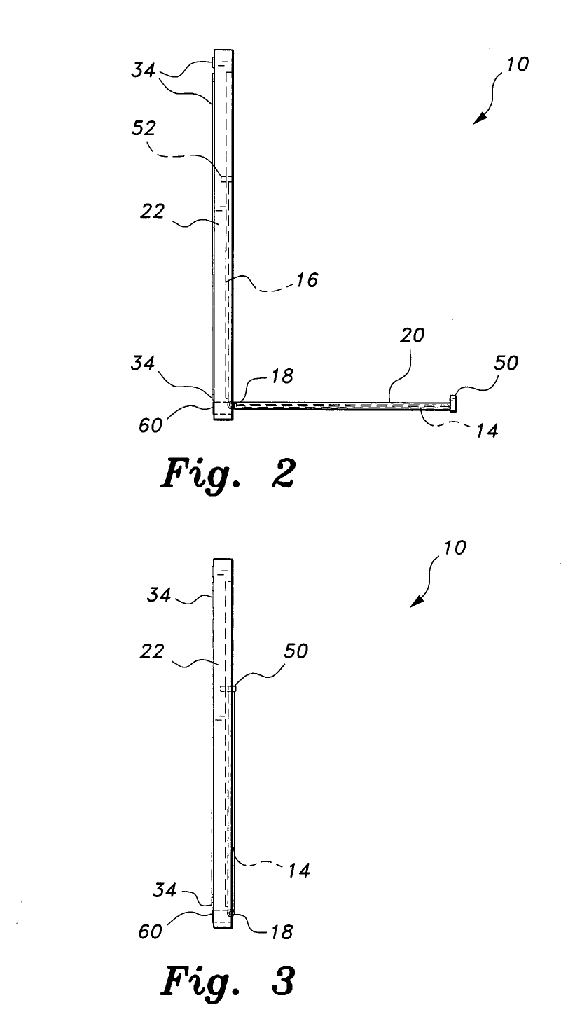

As shown in FIGS. 2-5, the auxiliary shelf and display 10 includes a vertical display portion 22, which is divided into an upper portion 28 and a lower portion 30. The vertical display portion 22 preferably has a substantially planar and rectangular configuration having a front surface and a rear surface. The rear surface 32 is adapted for releasable attachment to a support surface of the appliance or article of furniture, as will be described in greater detail below. Vertical display portion 22 may be constructed from any suitable material.

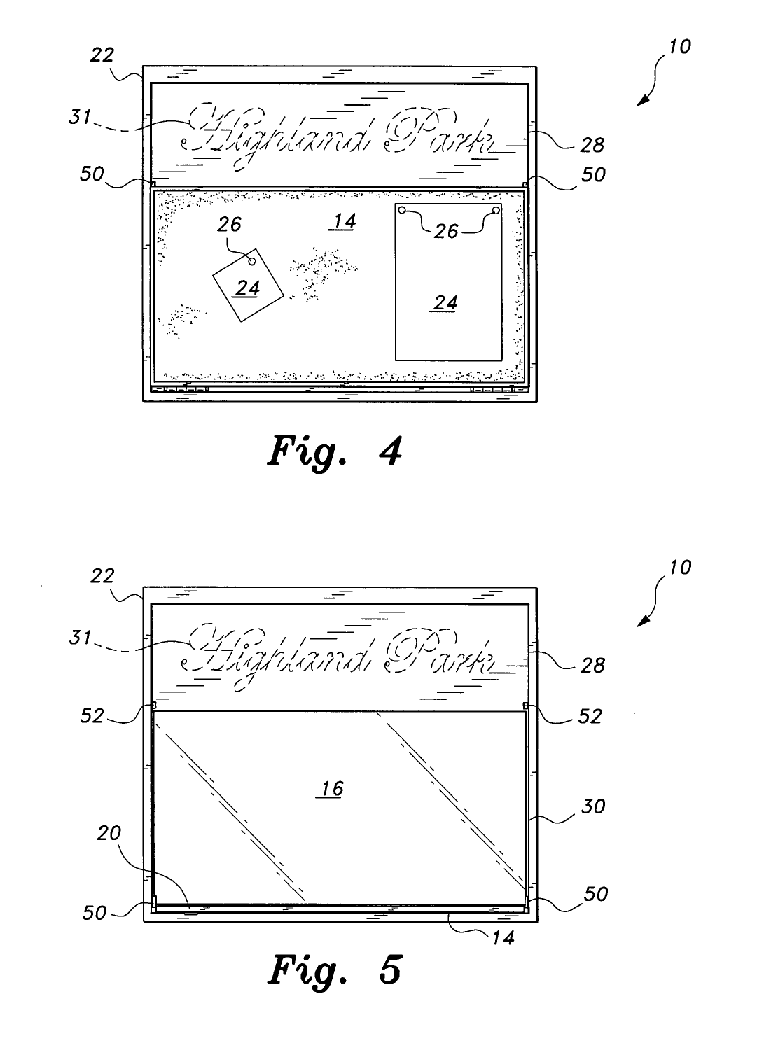

FIGS. 2 and 5 illustrate the auxiliary shelf and display 10 in a deployed, or open, configuration. As will be described in greater detail below, a shelf portion 20 is pivotally joined to a lower edge of vertical portion 22. In the open or deployed configuration, lower portion 30 of vertical portion 22 is visible to the user. In the closed configuration of FIGS. 3 and 4, the shelf portion 20 covers the lower portion 30.

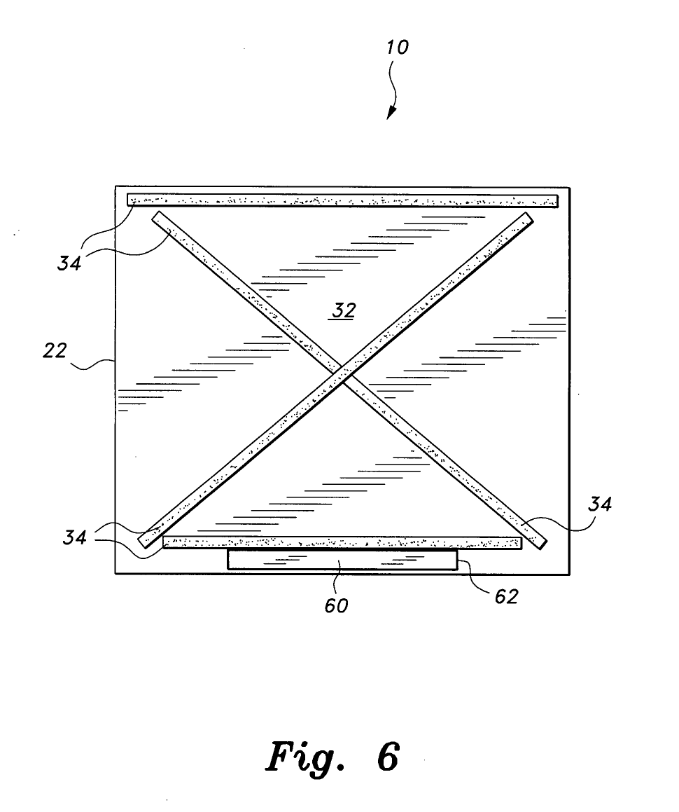

As shown in FIG. 6, a fastener for releasably securing the rear surface 32 of the vertical support portion 22 to the appliance or article of furniture is provided. For example, at least one magnetic member, such as a piece of magnetic tape 34, may be secured to the rear surface if the appliance or article of furniture is formed from metal. Alternatively, an adhesive strip may be used for releasably securing the rear surface to a nonmagnetic surface, such as wood paneling. It should be understood that a combination of magnetic members and adhesive may be used, or, alternatively, any suitable means for releasably mounting the system 10 to a support surface may be used.

As shown in FIGS. 4 and 5, the upper portion 28 of the vertical display portion 22 may have user-selectable indicia 31 formed thereon, such as advertising-related wording or images, or may have user-selectable and replaceable photographs affixed thereto. Any suitable text or images may be imprinted or otherwise formed on upper portion 28. The lower portion may have a mirror 16 mounted thereto, or may, alternatively, have an imprinted surface, such as a calendar, formed thereon. In the open configuration of FIG. 5, the exemplary mirror 16 is displayed to the user, and in the closed configuration of FIG. 4, the exemplary mirror 16 is hidden from the user, with display board 1 4 being visible (to be described in greater detail below).

As noted above, shelf portion 20 is pivotally mounted to a lower edge of the vertical display portion 22 so that the lower portion 30 of the vertical display portion 22 is covered by the shelf portion 20 when the shelf portion 20 is in a collapsed configuration. The shelf portion includes opposed first and second surfaces, with the first surface being adapted for supporting user-selectable articles when the shelf is in a deployed configuration. The second surface of the shelf portion has a corkboard 14 or other display surface mounted thereto, such as a bulletin board, which is visible to the user when the shelf is in the collapsed configuration. The shelf portion 20 is pivotally held to the vertical display portion 22 through use of a hinge 18 or the like. Any suitable pivotal mounting fixture may be used. It should be further understood that the corkboard 14 illustrated in FIG. 4 is shown for exemplary purposes only, and that any suitable display or display board, such as a dry erase board, that allows for changing messages or images on the display 14 may be used. Similarly, notes 24 held to the corkboard 14 by pushpins 26 are shown only for exemplary purposes.

An engagement member 50, such as a peg, for example, may be mounted to a forward edge of the shelf portion 20, the engagement member 50 being received within a corresponding recess 52 formed in the periphery of the vertical display portion 22. Engagement member 50 may be a peg, a clip, a tensioned retaining member, such as those generally associated with telephone plugs, or may be any suitable latch or retaining device.

The engagement member 50 is releasably held within the recess 52 for releasably securing the shelf portion 20 to the vertical display portion 22 when the auxiliary shelf and display 10 is in the collapsed configuration shown in FIG. 3. Multiple such engagement members 50 may be mounted to the forward edge of shelf portion 20, forming a barrier or perforate wall for retaining articles on the upper surface thereof. Alternatively, a raised, continuous peripheral wall may be formed on the forward edge of shelf portion 20.

The shelf portion 20 may be held in the open configuration through any suitable means. For example, a projecting member 60 may be mounted to the rear edge of the shelf portion 20 so that when shelf portion 20 is in the deployed configuration, the projecting member 60 is received within a slot 62 (shown in FIG. 6) formed in vertical portion 22, to prevent further downward rotation of shelf portion 20.

It is to be understood that the present invention is not limited to the embodiments described above, but encompasses any and all embodiments within the scope of the following claims.

We claim:

1. An auxiliary shelf and display, comprising:
a vertical display portion having opposed front and rear surfaces, the front surface having an upper portion and a lower portion, the upper portion being adapted for having user-selectable indicia imprinted thereon, the vertical display portion further having a lower edge;
a shelf portion having opposed first and second surfaces, a rear edge of said shelf portion being pivotally joined to the lower edge of said vertical display portion, the first surface being adapted for supporting user-selectable articles when the auxiliary shelf and display is in a deployed configuration;
means for releasably securing the rear surface of said vertical display portion to a support surface;
means for releasably securing a forward edge of said shelf portion to said vertical display portion when the auxiliary shelf and display is in a collapsed configuration; and,
a display board mounted to the second surface of said shelf portion, the display board being visible to a passerby when the auxiliary shelf and display is in the collapsed configuration.

2. The auxiliary shelf and display according to claim 1, further comprising a mirror mounted to the lower portion of said vertical display portion.

3. The auxiliary shelf and display as recited in claim 1, wherein said means for releasably securing the rear surface of said vertical display portion to a support surface comprises at least one magnetic member mounted to the rear surface.

4. The auxiliary shelf and display as recited in claim 1, wherein said means for releasably securing the rear surface of said vertical display portion to a support surface comprises at least one adhesive panel.

5. The auxiliary shelf and display as recited in claim 1, wherein said display board is a bulletin board.

6. The auxiliary shelf and display as recited in claim 5, wherein the bulletin board is a corkboard.

7. The auxiliary shelf and display as recited in claim 1, wherein said means for releasably securing a forward edge of said shelf portion to said vertical display portion when the auxiliary shelf and display is in a collapsed configuration comprises at least one engagement member mounted to the forward edge of said shelf portion, the at least one engagement member being releasably received within at least one recess formed in the front surface of said vertical display portion.

8. The auxiliary shelf and display as recited in claim 1, further comprising at least one hinge mounted to the rear edge of said shelf portion and the lower edge of said vertical display portion.

9. The auxiliary shelf and display as recited in claim 1, further comprising a projecting member extending from the rear edge of said shelf portion, a corresponding slot being formed through the lower edge of said vertical display portion, whereby when the shelf portion is in the deployed configuration, the projecting member engages the slot to prevent further downward rotation of said shelf portion.
